(19) United States
(12) Patent Application Publication
(10) Pub. No.: US 2021/0169053 A1
(43) Pub. Date: Jun. 10, 2021

(54) Method for Neutralizing and Removing Ammonia from an Aqueous Solution

(71) Applicant: Hydrenesis, Inc., Pompano Beach, FL (US)

(72) Inventor: Luke Stephen Timmons, Pompano Beach, FL (US)

(73) Assignee: Hydrenesis, Inc., Pompano Beach, FL (US)

(21) Appl. No.: 17/061,894

(22) Filed: Oct. 2, 2020

Related U.S. Application Data
(60) Provisional application No. 62/909,765, filed on Oct. 2, 2019.

(51) Int. Cl. A01K 63/04; C02F 1/70; C02F 1/72; C02F 1/76; C25B 1/02; C25B 1/26; C25B 1/50; C25B 15/08

(52) U.S. Cl. CPC A01K 63/04; C02F 1/70; C02F 1/725; C02F 1/763; C02F 2101/16; C25B 1/02; C25B 1/26; C25B 1/50; C25B 15/081; C02F 1/766

(57) ABSTRACT

A method to reduce ammonia levels in an aqueous solution. Hydrogen and chlorine gases are injected into a closed-loop aqueous tank containing the toxic ammonia compound to incite various chemical reactions. Bi-products resulting from the various chemical reactions are removed with filtration and/or adsorption to effectively remove the toxins and contaminants from the aqueous solution.

### TECHNICAL FIELD

These claimed embodiments relate to a method for neutralizing for removing ammonia from an aqueous solution.

### BACKGROUND OF THE INVENTION

A method and apparatus for neutralizing and removing ammonia from any aqueous solution is disclosed.

In an aquaculture application in which the finfish or shrimp are farmed in a self-contained aqueous solution in a closed loop environment, the waste from the shrimp generates toxic ammonia. High amounts of ammonia result in mortality events in the fish or shrimp. Bi-products of attempts to treat the solution and remove the ammonia have also killed the shrimp/fish. Many solutions to remove the bi-products have required costly filtration or chemicals being added to the aqueous solution.

Processes have used electrolytic cells to produce gases from reactions in the treatment of water in aquaculture applications. Other processes have used electrolytic cells to produce a chemical reaction while submerged in the treatment loop in aquaculture applications, this process is known to be very inefficient and not cost effective in the aquaculture application. Such systems also only work in saltwater species, as they depend on sodium chloride in the aquaculture medium to serve as a weak electrolyte.

Many prior processes are not very efficient and have not been cost effective in neutralizing the ammonia. Examples of prior processes and principles are described in “Ionization of ammonia and deuterated ammonia by electron impact from threshold up to 180 eV”, J. Chem. Phys. 67, 3795 (1977) by T. D. Mark, F. Egger, and M. Cheret, Synergy of Water and Ammonia Hydrogen Bonding in a Gas-Phase Reaction, Wen Chao, Cangtao Yin, Yu-Lin Li, Kaito Takahashi, Jim Jr-Min Lin, J. Phys. Chem. A 2019, 123, 7, 1337-1342, Jan. 25, 2019 of the American Chemical Society.

### SUMMARY OF THE INVENTION

One general aspect includes a method for reducing the ammonia level of an aqueous solution in a tank. The method includes applying a positive electrically charged current into a brine solution in a first chamber. A negatively charged current is applied into a caustic solution in a second chamber separated from the first chamber by a membrane resulting in Hydrogen gas (H₂) being extracted from the caustic solution in the second chamber and chlorine gas being extracted from the brine solution in the first chamber. The extracted hydrogen gas is injected into the aqueous solution containing un-ionized ammonia to neutralize the un-ionized ammonia by converting the un-ionized ammonia to ammonium (ionized ammonia). Chlorine gas is injected into the ammonium to produce a chloramine byproduct. Byproducts produced from the injection are filtered to produce an ammonia free solution. The ammonia free solution is fed back in the aqueous tank. The chlorine gas or hydrogen gas may be injected into the ammonium at a rate based on ammonia concentration originating from the aqueous tank. The chlorine gas or hydrogen gas may be injected at a rate based on a concentration of bacteria and parasitic entities in the aqueous tank. The byproducts produced from the injection into the aqueous stream may be filtered using a catalytic carbon filter.

In another embodiment, a method of toxic ammonia compound removal from an aqueous solution includes injecting hydrogen and chlorine gases into a closed-loop aqueous tank containing the toxic ammonia compound to incite various chemical reactions. Bi-products resulting from the various chemical reactions may be removed with filtration and adsorption to effectively eliminate all of the toxic ammonia compounds. The aqueous solution may contain an aquatic species.

In a further implementation, a method of neutralizing the toxic action of un-ionized ammonia (NH₃) within a solution containing an aquatic species includes ionizing the un-ionized ammonia, originating from the solution containing the aquatic species, with electrolytically produced hydrogen gas (H₂) to form a neutralized ionized ammonia (NH₄+). The neutralized ionized ammonia may be injected into the solution containing the aquatic species. A flow and volume of the un-ionized ammonia may be altered to increase contact time with the gases based on the concentration of bacteria in the solution containing the aquatic species. Chlorine gases may be injected into the neutralized ionized ammonia to produce chloramine byproducts. Byproducts produced from the injection of the chlorine gases into the neutralized ionized ammonia may be filtered to produce an ammonia free solution, and the ammonia free solution may be re-injected into the solution containing the aquatic species.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a system diagram illustrating an operation of a membrane separation cell;

FIG. 2 is a system diagram illustrating an apparatus for producing chlorine and hydrogen gases using a chemical storage device, a dry electrolytic cell chamber, a gas delivery apparatus, and a membrane assembly; and

FIG. 3 is a flow diagram of a process for extracting ammonia from an aqueous solution using the apparatus shown in FIGS. 1 and 2.

FIG. 4 is a chart showing the effects of Ammonia concentrations in water on various aquatics species over a 48-hour period.

FIG. 5 is a chart showing a relationship between bacterial survival on chlorine concentration decay in a solution over a 30-minute time period.

### DETAILED DESCRIPTION

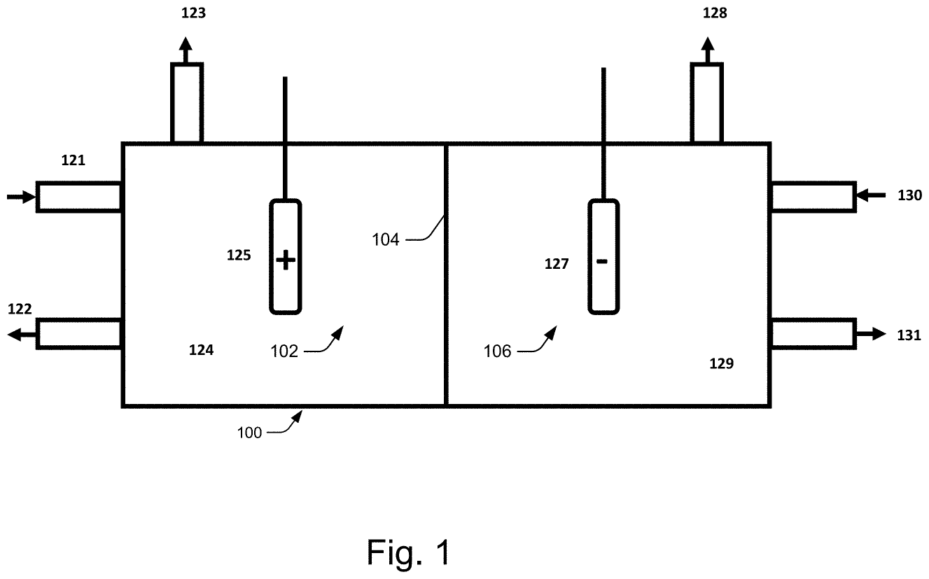

In FIG. 1 there is shown a membrane separation cell 100 using a chloralkali process. The most common chloralkali process involves the electrolysis of aqueous sodium chloride (a brine, a saline or an aqueous based solution) in a membrane cell. Cell 100 includes first chamber 102 coupled through Polytetrafluoroethylene membrane 104 to second chamber 106.

First chamber 102 is coupled to a brine input 121, a recycled exhausted brine output 122, and a Cl₂ gas output 123. Second chamber 106 is coupled to a water (H₂O) input 130, a NaOH recycle output 131, and a Hydrogen (H₂) gas output 128. An anode 125 is inserted into first chamber 102 to supply a positive charge to solution in chamber 102, and a cathode 127 is inserted into second chamber 106 to supply a negative charge to solution in chamber 106. Anode 125 and cathode 127 are connected to the positive and negative terminals respectively of a Distributed Current power source (not shown).

Saturated brine solution 124 is passed via brine input 121 into the first chamber 102 of the cell 100, and water is passed into the second chamber via water input 130. In first chamber 102 the chloride ions in the Brine solution are oxidized at the anode 125, losing electrons to become chlorine gas using the equation:

2Cl−→Cl₂+2e−

At the cathode 127, positive hydrogen ions pulled from water molecules are reduced to hydrogen gas by the electrons that are provided by the electrolytic current, thereby releasing hydroxide ions into the solution using the formula:

2H₂O+2e−→H₂+2OH−

The ion-permeable ion exchange membrane 104, separating the first chamber 102 from the second chamber 106, allows sodium ions (Na+) in brine solution 124 in the first chamber 102 to pass to the second chamber where they react with the hydroxide ions in water 129 in chamber 106 to produce a caustic soda.

The overall reaction for the electrolysis of brine is thus:

2NaCl+2H₂O→Cl₂+H₂+2NaOH

Thus membrane 104 prevents the reaction between the chlorine in the brine and hydroxide ions in water. If this reaction were to occur, the chlorine would disproportionately form chloride and hypochlorite ions using the equation:

Cl₂+2OH−→Cl−+ClO−+H₂O

If the brine is heated to above 60° C., chlorate can be formed citing the equation:

3Cl₂+6OH−→5Cl−+ClO₂−+3H₂O

Due to the corrosive nature of chlorine production, the anode 125 (where the chlorine is formed) should be non-reactive and in one implementation made from platinum metal, graphite, or a mixed metal oxide clad titanium anode (also referred to as a dimensionally stable anode). Historically, magnetite, lead dioxide, manganese dioxide, and ferrosilicon have also been used as anodes. Unclad titanium cannot be used as an anode because it anodizes, forming a non-conductive oxide and passivates.

In one implementation, the cathode 127 (where hydroxide forms) is constructed from unalloyed titanium, graphite, or a more easily oxidized metal such as stainless steel or nickel. If current applied to Anode 125 and Cathode 127 is interrupted while cathode 127 is submerged, cathodes constructed from easily oxidized materials such as stainless steel could dissolve in an unpartitioned cell.

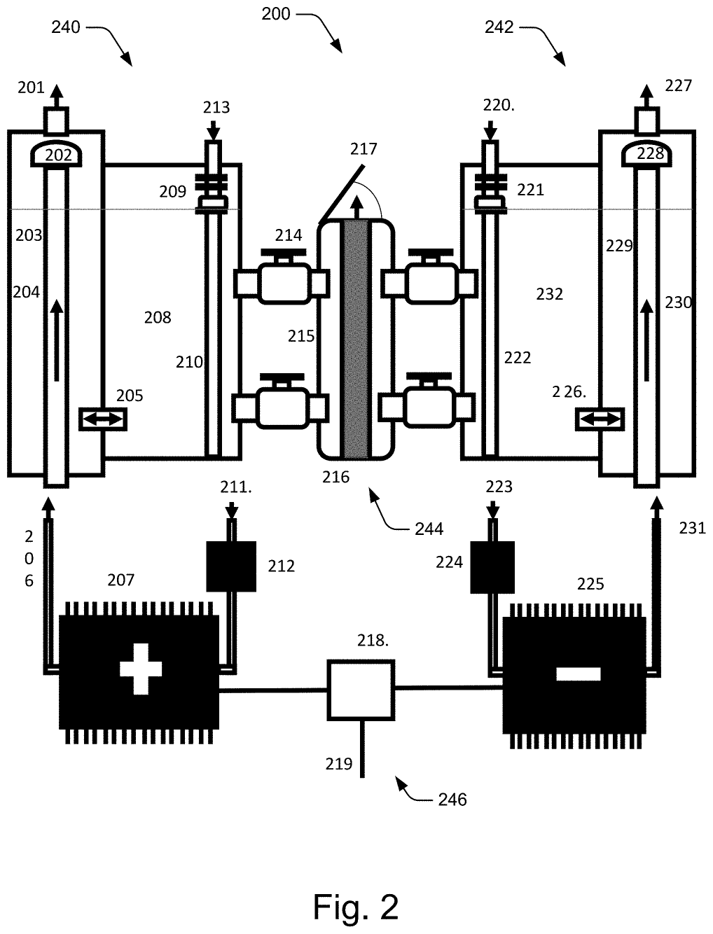

Referring to FIG. 2, there is shown a system diagram of a gas production device 200 that includes chemical storage device 240 coupled to gas delivery apparatus in chamber 242 via a membrane assembly 244. Coupled to chemical storage device 240 and gas delivery apparatus in chamber 242 is dry cell chambers 246.

Chemical storage device chamber 240 includes a Cl₂ gas out valve 201 a Cl₂ Off-Gas Bell 202, a Cl₂ Delivery Riser Tube 203, a Cl₂ Atmospheric Isolated Pressure Vessel 204, a Submerged Brine Vessel Manifold 205, a 26-28% Brine Solution (NaCl) tank 208, a Float/Autofill/Shut-off Assembly 209 and a Fill Tube/Turbulator 210.

Gas delivery apparatus 242 includes a Caustic Side Fresh H₂0 Inlet 220, a Float/Autofill/Shut-off Assembly 221, a Fill Tube/Turbulator 222, a Submerged Caustic Vessel Manifold 226, a H₂ Gas Outlet 227, a H₂ Off-Gas Bell 228, a H₂ Delivery Riser Tube 229 and a H₂ Atmospheric Isolated Pressure Vessel 230.

In one implementation the electrolytic solution vessels 204 and vessels 230 will be applied on a negative pressure application only. Water will be automatically filled through an assembly that responds to a float for fluid level controls. The assembly may contain an overfill emergency shutoff in case there is a blockage.

The tank 208 (filled with brine solution) and tank 232 (filled with a caustic solution) are separated atmospherically but manifolded below the water level. This allows a displacement in the event of a pressure build-up that will cause the main vessel waterline to rise, triggering a system shutdown.

Feeds 213 and 220 may consist of purified Reverse Osmosis water. The Brine side tank 208 will periodically require pure NaCl be inserted into the feed in the form of powder, granules, or crystalized rock salt. In the case of the latter, time will be needed to dissolve the NaCl before operation.

Membrane assembly 244, includes a Polytetrafluoroethylene Membrane 215 coupled with a Membrane Isolation Valve Manifold 214, a Membrane Isolation Drain 216 and a Membrane Isolation Maintenance Access 217.

The Polytetrafluoroethylene membrane 215 could occasionally wear out and need to be replaced to prevent cross contamination of the two solutions. To change the membrane 215, the isolation manifold 214 may need to be manipulated to separate a membrane chamber (the chamber where membrane 215 is held) from main vessels. A drain 216 at the bottom of the chamber will prevent the solutions from mixing during maintenance.

Access to the membrane 215 may be achieved through access panel 217 on the top of the vessel. Cartridge based membranes may be utilized to replace membrane 215 for ease of use.

Dry cell chambers 246 includes Power Converter/Pulse Width Modulation/Bridge Rectifier 218 coupled to a Brine Side Anode Dry Cell (Platinum/graphite/titanium) 207 and a Caustic Side Cathode Dry Cell 225 (with 316 Stainless Steel). Rectifier 218 receives AC (Alternating current) power 219 that is converted to DC (direct current) power that is supplied to Cell 207 and Cell 225. Cell 207 receives brine in chamber 240 via Dry cell Brine delivery tube 211 using brine recirculation pump 212 and supplies positively charged brine to chamber 240 via Cl₂ Dry Cell Return Line 206. Cell 225 receives water in chamber 242 via Dry cell caustic delivery tube 223 using caustic recirculation pump 224 and supplies negatively charged water to chamber 242 via H₂ Dry Cell Return Line 231.

Electrolytic solution is passed through the dry cell chambers 246 with a recirculation pumps 224 to increase circulation and enable efficient cooling. In one implementation, the pumps generate a 7-10 GPM Flow rate.

In one implementation the plates within chambers 246 will be made of Platinum, Titanium, graphene, or some variation of graphite for the Cl₂/brine side cell 207, and 216 Stainless for the H₂/Caustic Side cell 225.

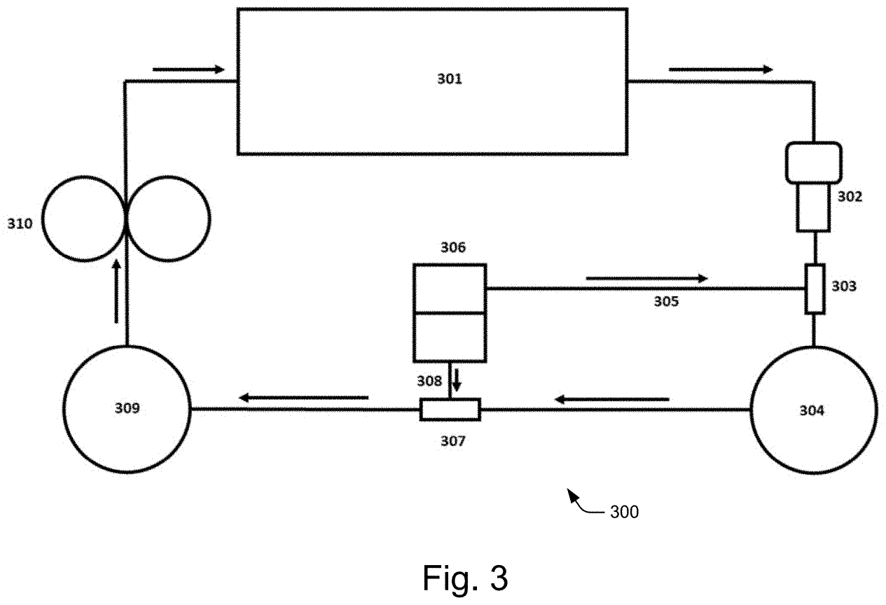

Referring to FIG. 3, there is shown a system 300 for extracting and neutralizing ammonia from an aquaculture container. System 300 includes a Water Column with Aquatic Species or any water tank 301, coupled via Recirculation Pump 302, and H₂ Venturi Injector 303 to H₂ Contact/Mixing Tank 304. Tank 301 contains a solution that contains a concentration of ammonia (NH₃) and/or bacteria generated by aquaculture (e.g. shrimp, fin-fish, crustaceous).

Mixing tank 304 is coupled via Cl₂ venturi 307 to mixing tank 309. Reducing Gas Venturi Injection 309 is coupled via catalytic carbon filter 310 to tank 301. Gas production device 306 (FIG. 1 and/or 2) is coupled to H₂ Venturi Injector 303 via H₂ Delivery Line 305 and is coupled to Cl₂ mixing tank 309 via Cl₂ Gas Delivery Line 308 and Cl₂ venturi 307. Gas production device 306 may be connected to an external source of Cl₂ gas or electrolytically produced H₂ gas.

System 300 removes ammonia (NH₃) from a water tank 301 by manipulation of certain chemical reactions, induced by the apparatus and method in any recirculating water system 300.

Water/solution is extracted from tank 301 at an appropriate pipe diameter with an appropriate recirculation pump 302 based on volume and flow. Next, electrolytically produced Hydrogen Gas H₂, or Hydronium (also referred to herein as a “reducing gas”) is injected from the gas production device 306 (The embodiment in FIG. 2 or from an external source) via a pressure differential venturi using injector 303. From there, the water is passed through a baffled contact/mixing tank 304.

In mixing tank 304 the reducing gas reacts to ionize any unionized ammonia (NH₃) into ionized ammonium (NH₄+). In mixing tank 304 the reducing gas reacts to ionize any un-ionized ammonia (NH₃) into ionized ammonium (NH₄⁺). In solution, hydronium(H+) cations form in the presence of hydrogen atoms (H₂). The weak base NH₃ attracts a proton from the hydronium ions in solution.

The chemical reaction is as follows:

H⁺+NH₃^{→}NH₄⁺

Four gallons(15 L) of aquaculture medium were added to a vessel. 20 early stage larval White Shrimp (Penaeus vannamei) were then added to bucket. The shrimp were fed the appropriate amounts of industry standard feed, and oxygen was added to the bucket. No water filtration methods were used.

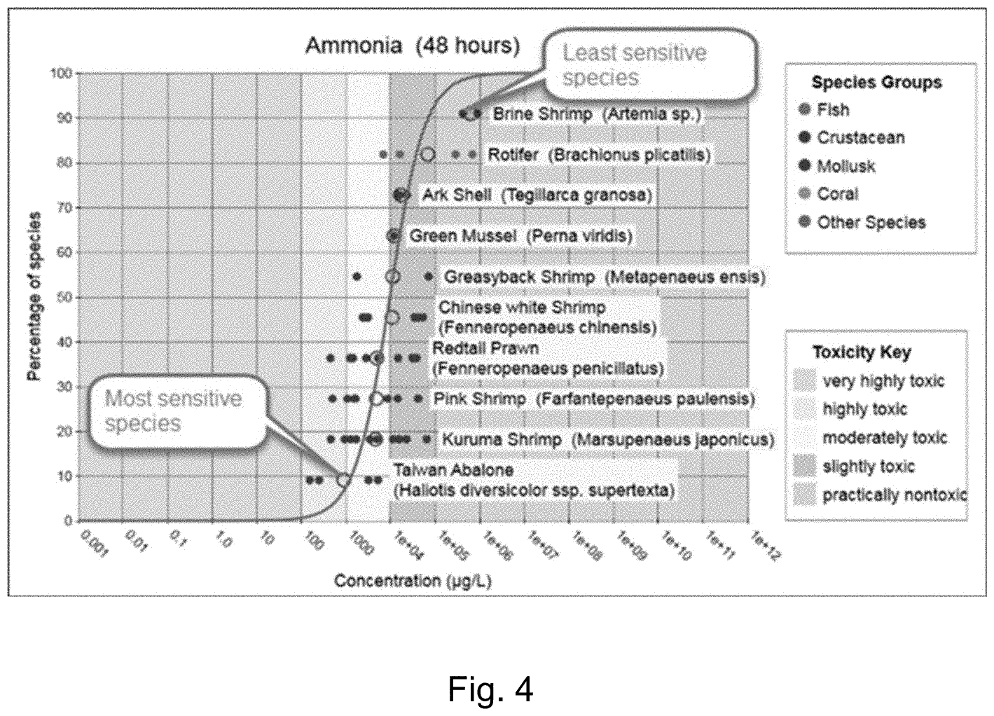

A constant stream of Hydrogen gas was introduced into the bucket through aeration stone for the duration of the experiment. The species of shrimp used has a very low total ammonia nitrogen (TAN) tolerance (see FIG. 4). These 20 shrimps in the bucket survived until the TAN levels were 90 ppm, over 72 hours later. Upon post-mortem examination of non-surviving shrimp, it was determined that the shrimp were killed by toxic levels of carbon dioxide, most likely a result of inadequate off gassing in the test vessel. In experiment 1, neutralized NH₄+ was the only constituent of TAN present in the treatment test medium.

All the ammonia in the water post mixing tank 304 was ionized ammonia. This reaction once H₂ was injected occurred in seconds. The mixing tank 304 ensured complete contact and conversion of the chemical species.

Upon water exiting mixing tank 304, chlorine gas (Cl⁻) is injected from gas production device 306 into the exiting water stream via Cl₂ Gas Delivery Line 308 and pressure-differential venturi 307. Chlorine gas may be obtained from the embodiment in described in FIG. 2 or from an external source. The rate of the chlorine gas injection may be a function of, and may be automatically adjusted in response to, changes in the bacteria or ammonia concentration of the solution in the aqueous tank 301 (using a feedback sensor in tank 301 and a controller—not shown).

Through combination static-mixer or baffle tank 309, ionized ammonia reacts with chlorine gas to create several biproducts.

The chemical reaction(s) are as follows:

2NH₃+CL₂=2NH₂Cl

NH₃+3Cl₂═NCl₃+3H⁺+3Cl⁻

NH₄⁺+3Cl₂═NCl₃+NCl₃+4H⁺+3Cl⁻

A practical example of these reactions in use is at a municipal water treatment plant. The operators add these amines to produce inorganic chloramines that improve the disinfecting power, and control waterborne disease. The US EPA has accepted chloramine as a disinfectant and recognized its ability to control THM formation. In this embodiment, water is disinfected in the process loop.

When the water leaves the mixing tank 309, only forms of chloramine and other haloform reaction bi-products remain. The pH and ammonia-chlorine equilibrium determine which types of Chloramines are formed. These bi-products are commonly known and accepted to be completely and easily removed by catalytic carbon filter 310 or other industry standard medias when the correct media volume and flowrate are applied. Catalytic carbon is an inert, porous support material, it can be used to apply chemicals on its large internal surface, thus making them accessible to reactants (chloramines in this case).

The chemical mechanism can be explained in two steps:

NH₂Cl+H₂O+C→NH₃+H++Cl−+CO and,

NH₂Cl+CO→N₂+2H++2Cl−+H₂O+C

The process will be appropriately sized, with twin-alternating pressure vessels containing proper media volume, 24-hour operation, and correct backwash settings.

Media sizing of the vessel may be most effective if applied in a manner consistent with 2.5 GPM flow rate per 1 cu/ft of media surface area.

In this experiment, the treated water then returns to the water column 301 with zero detectable ammonia.

Additional benefits are derived and manipulated from the contact time of various disinfectant properties of chemicals produced and applied through the process.

Both chloramine and chlorine compounds may be used as commonly accepted disinfecting agents for municipal water treatment.

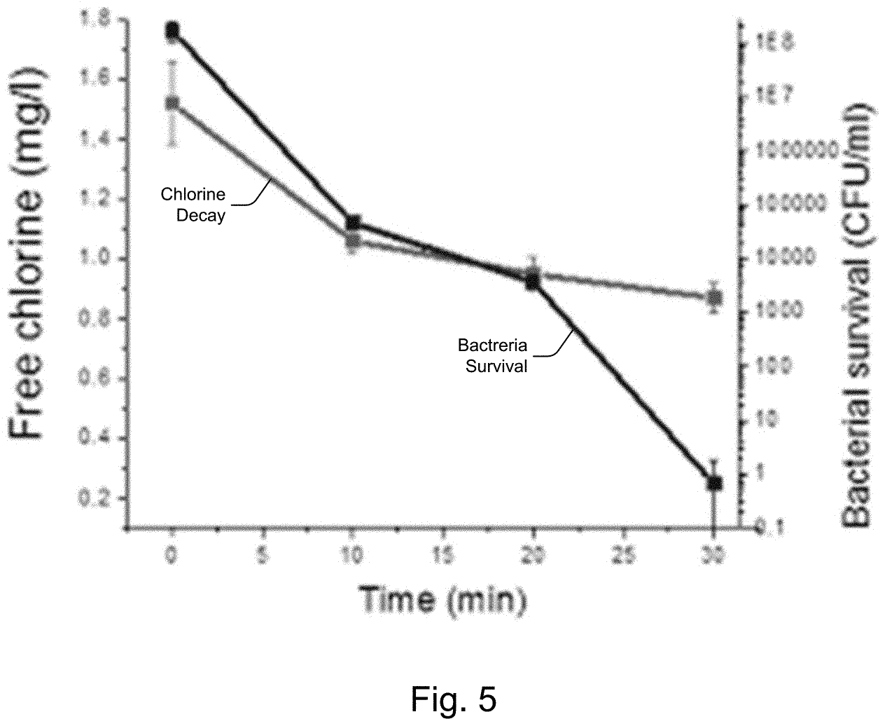

In another implementation, the flowrate is slowed, or the mixing apparatus is made larger to induce longer disinfection contact time. (See FIG. 5) The flowrate may be increased or slowed to change the concentration of ammonia or bacteria in the aqueous tank 301.

The result would not affect the ammonia removal function, while imparting additional sterilization (of bacteria) action. Such sterilization may be a value-add in numerous applications.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A method for toxic ammonia compound removal from an aqueous solution originating from an aqueous tank, the method comprising:
applying a positive electrically charged current into a brine solution in a first chamber;
applying a negatively charged current into a caustic solution in a second chamber separated from the first chamber by a membrane resulting in Hydrogen gas (H₂) being extracted from the caustic solution in the second chamber and chlorine gas being extracting from the brine solution in the first chamber;
injecting the extracted hydrogen gas into the aqueous solution containing un-ionized ammonia to neutralize the un-ionized ammonia by converting the un-ionized ammonia to ammonium;
injecting chlorine gas into the ammonium to produce chloramine byproduct;
filtering chloramine byproducts to produce an ammonia free solution; and
feeding the ammonia free solution back in the aqueous tank.

2. The method as recited in claim 1, wherein the Hydrogen gas (H₂) is electrolytically produced.

3. The method as recited in claim 1, wherein injecting the extracted hydrogen gas into the aqueous solution includes injecting the extracted hydrogen gas into a mixing tank with the aqueous solution to ensure the hydrogen gas completely dissolves into the aqueous solution.

4. The method as recited in claim 1, wherein the aqueous tank includes at least one of shrimp, finfish, or crustaceans.

5. The method as recited in claim 1, wherein injecting chlorine gas includes injecting the chlorine gas or hydrogen gas into the ammonium at a rate based on ammonia concentration originating from the aqueous tank.

6. The method as recited in claim 1, wherein injecting chlorine gas or hydrogen gas is injected at a rate based on a concentration of bacteria and parasitic entities in the aqueous tank.

7. The method as recited in claim 1, wherein filtering the byproducts produced from the injection into the chloramine includes using a catalytic carbon filter.

8. The method as recited in claim 1, wherein the aqueous tank includes a water column.

9. A method of toxic ammonia compound removal from an aqueous solution comprising:
injecting hydrogen and chlorine gases into a closed-loop aqueous tank containing the toxic ammonia compound to incite various chemical reactions; and
removing bi-products resulting from the various chemical reactions with filtration and adsorption, to effectively remove the toxic ammonia compounds.

10. The method as recited in claim 9, wherein the aqueous solution contains an aquatic species.

11. The method as recited in claim 9, removing bi-products resulting from the various chemical reactions with filtration and adsorption includes using a catalytic carbon filter to remove the bi-products.

12. A method of neutralizing toxic action of un-ionized ammonia (NH₃) within a solution containing an aquatic species, comprising:
ionizing the un-ionized ammonia, originating from the solution containing the aquatic species, with electrolytically produced hydrogen gas (H₂) to form a neutralized ionized ammonia (NH₄⁺).

13. The method as recited in claim 12 comprising:
injecting the neutralized ionized ammonia into the solution containing the aquatic species.

14. The method as recited in claim 12, wherein the un-ionized ammonia originates from the solution in a solution stream, the method further comprising:
injecting chlorine gas into the neutralized ionized ammonia to produce a chloramine byproduct; and
altering a flow and volume of the solution stream to increase contact time with the chlorine gas injected into the neutralized ionized ammonia based on a concentration of bacteria in the solution containing the aquatic species.

15. The method as recited in claim 12 comprising:
injecting chlorine gases into the neutralized ionized ammonia to produce chloramine byproduct.

16. The method as recited in claim 15 comprising:
filtering the chloramine byproduct produced from the injection of the chlorine gases into the neutralized ionized ammonia to produce an ammonia free solution; and
injecting the ammonia free solution into the solution containing the aquatic species.

17. The method as recited in claim 12, wherein the aquatic species includes at least one of shrimp, fin fish, or crustaceans.
